(19) United States
(12) Patent Application Publication
(10) Pub. No.: US 2022/0324348 A1
(43) Pub. Date: Oct. 13, 2022

(54) Method and System for Determining an Electrical System State of at Least One Motor Vehicle

(71) Applicant: Volkswagen Aktiengesellschaft, Wolfsburg (DE)

(72) Inventors: Marco Friederich, Braunschweig (DE); Martin Döring, Braunschweig (DE)

(73) Assignee: Volkswagen Aktiengesellschaft, Wolfsburg (DE)

(21) Appl. No.: 17/639,207

(22) PCT Filed: Aug. 5, 2020
(86) PCT No.: PCT/EP2020/072025

§ 371 Date: Feb. 28, 2022

(30) Foreign Application Priority Data
Aug. 29, 2019 (DE) 10 2019 213 010.0

(51) Int. Cl. B60L 58/12; G07C 5/00; G08G 1/00

(52) U.S. Cl. CPC B60L 58/12; G07C 5/008; G08G 1/20

(57) ABSTRACT

The disclosure relates to a method for determining an electrical system state of at least one motor vehicle, wherein electrical state data of the at least one motor vehicle are detected on the vehicle side by means of a power distribution unit in the at least one motor vehicle, wherein the detected electrical state data are transmitted to a central server by means of a communications interface, wherein the transmitted electrical state data are compared on the server side with at least one reference value, and wherein, starting from a comparison result, the electrical system state of the at least one motor vehicle is determined and provided. The disclosure further relates to a system for determining an electrical system state of at least one motor vehicle, a motor vehicle, and a central server.

### CROSS-REFERENCE TO RELATED APPLICATIONS

This application claims priority to German Patent Application No. DE 10 2019 213 010.0 filed on Aug. 29, 2019 with the German Patent and Trademark Office. The contents of the aforesaid Patent Application are incorporated herein for all purposes.

### TECHNICAL FIELD

The invention relates to a method and a system for determining an electrical system state of at least one motor vehicle. The invention further relates to a motor vehicle and a central server for such a system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Modern motor vehicles have on the consumer side a plurality of electrical components, which are electrically connected to an energy source, in particular a battery, of the motor vehicle via various line branches of an electrical system of the motor vehicle. To determine an electrical system state, complex diagnostic methods are necessary. In particular, separate diagnostic functions for this purpose are integrated into control devices of the individual electrical components and read out at a shop.

Until now, determining an electrical system state has only been solved unsatisfactorily.

### SUMMARY

A need exists to improve a method and a system for determining an electrical system state of at least one motor vehicle.

The need is addressed by a method, a system, a motor vehicle, and a central server having the features of the independent claims. Some embodiments are apparent from the dependent claims, the following description, and the drawings.

### BRIEF DESCRIPTION OF THE DRAWINGS

FIG. 1 shows a schematic representation of an embodiment of a system for determining an electrical system state of at least one motor vehicle;

FIG. 2 shows a schematic representation to illustrate an embodiment of determining and establishing at least one reference value; and

FIG. 3 shows a schematic process diagram of an embodiment of the method for determining an electrical system state of at least one motor vehicle.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In particular, a method for determining an electrical system state of at least one motor vehicle is provided, wherein electrical state data of the at least one motor vehicle are detected on the vehicle side by means of a power distribution unit in the at least one motor vehicle, wherein the detected electrical state data are transmitted to a central server by means of a communications interface, wherein the transmitted electrical state data are compared on the server side with at least one reference value, and wherein the electrical system state of the at least one motor vehicle is determined and provided starting from a comparison result.

Furthermore, in particular a system for determining an electrical system state of at least one motor vehicle is provided, comprising at least one motor vehicle with a power distribution unit and a communications interface, and a central server, wherein the power distribution unit is designed to detect electrical state data of the at least one motor vehicle and to transmit the detected electrical state data to the central server by means of the communications interface, and wherein the central server is designed to compare the transmitted electrical state data with at least one reference value and, starting from a comparison result, to determine and provide the electrical system state of the at least one motor vehicle.

Furthermore, in particular a motor vehicle for a system for determining an electrical system state of at least one motor vehicle is provided, comprising a power distribution unit and a communications interface, wherein the power distribution unit is designed to detect electrical state data of the at least one motor vehicle and to transmit the detected electrical state data to the central server by means of the communications interface.

Furthermore, in particular a central server for a system for determining an electrical system state of at least one motor vehicle is provided, wherein the central server is designed to compare electrical state data transmitted by the at least one motor vehicle with at least one reference value and, starting from a comparison result, to determine and provide the electrical system state of the at least one motor vehicle.

The method and the system enable an electrical system state of a motor vehicle to be determined with reduced effort. The method is executed for at least one motor vehicle. In particular, the method is executed for a plurality of motor vehicles of a vehicle fleet. The at least one motor vehicle has a power distribution unit, which serves to connect line branches of the electrical system to an electrical energy source of the motor vehicle, in particular a battery, and to protect the electrical connections formed in each case, in particular by means of semiconductor fuses. In addition, the power distribution unit detects electrical state data of the at least one motor vehicle. Electrical state data comprise in particular a current electric current and a current electrical voltage at individual line branches, starting from the power distribution unit, of the electrical system of the at least one motor vehicle. The detected electrical state data are transmitted to a central server by means of a communications interface. This takes place in particular continuously so that current electrical state data are continuously available. The central server receives the transmitted electrical state data of the at least one motor vehicle and evaluates them. For this purpose, the transmitted electrical state data are compared in the central server with at least one reference value. Starting from a comparison result, the electrical system state of the at least one motor vehicle is determined and provided.

A benefit of the method and the system is that an electrical system state can be continuously monitored, since electrical state data of the at least one motor vehicle can be continuously transmitted. This enables predictive monitoring and diagnostics of errors in the electrical system. In addition, no other diagnostic functions are necessary in control devices of individual components of the electrical system, since the electrical state data for the entire electrical system, meaning for all line branches of the electrical system, can be detected and provided centrally by means of the power distribution unit. This reduces effort and costs.

The at least one reference value specifies for the electrical quantities (e.g., current and voltage) detected by the electrical state data, in particular, in which value range or in which value ranges the electrical quantities of the electrical state data may lie. It is in particular provided here that at least one reference value is specified for each line branch of the electrical system, meaning in particular a value range or value ranges of electrical quantities are defined as reference value(s) for each line branch of the electrical system. During the comparison, it is checked in particular whether or not the electrical quantities detected by the electrical state data lie within the value ranges specified as the respective reference value(s). Depending on the respective comparison result, the electrical system state is determined. The electrical system state comprises, for example, the comparison results, for example in the form of a list or assignment, in which it is indicated for each line branch of the electrical system whether or not the electrical quantities lie within the associated value ranges established by the at least one reference value.

A power distribution unit (PDU), also described as an electronic power distribution unit (ePDU), comprises in particular electrical semiconductor fuses with which electrical line branches of an electrical system of a motor vehicle are protected. In addition, at least one electric current that flows through the individual line branches is detected, in each case by means of a current sensor of the power distribution unit. The detected electric current is evaluated by a control apparatus of the power detection unit and compared in particular with a trip current. If the electric current detected at a line branch exceeds the trip current, an associated semiconductor fuse is tripped by means of the control apparatus and an electrical connection to the electrical line branch of the electrical system is disconnected. The state data transmitted by the power distribution unit comprise in particular at least the electric current detected for each of the line branches of the electrical system. In particular, however, it is provided that additional electrical quantities, for example an electrical voltage, an electrical resistance of line branches, etc., are detected and transmitted as part of the transmitted state data.

The communications interface of the power distribution unit and a communications interface of the central server are designed in particular as wirelessly working communications interfaces, for example by means of Wi-Fi, Bluetooth, mobile data connection or internet, etc.

In some embodiments, it is provided that the at least one reference value establishes at least one operating point for at least one line branch of an electrical system and/or of at least one component of the at least one motor vehicle. The at least one operating point comprises here in particular at least one value range of operating points. An operating point is here in particular a combination of a current and a voltage; it can, however, also comprise additional electrical quantities. By establishing at least one operating point, an operating point analysis can be performed during the comparison. This is particularly beneficial when multiple components are supplied by one line branch, so that both the currents and the voltages of the individual components must be taken into account. A currently calculated operating point can then be compared with value ranges, specified by the at least one reference value, for operating points of the line branch. In particular, it can be checked during the comparison whether or not current operating points lie outside of the specified value range or the specified value ranges.

In some embodiments, it is provided that the at least one reference value is determined and established taking into account transmitted electrical state data of motor vehicles of a vehicle fleet. This allows empirically detected reference values to be generated. In particular, motor vehicles are used here that are of the same type with regard to electrical equipment and an electrical configuration (the same line branches supply the same components, etc.). Expressed simply, electrical state data are collected from motor vehicles of the same type in a vehicle fleet and the at least one reference value is determined from the collected electrical state data. In particular, starting from the collected electrical state data, value ranges are defined in which electrical quantities usually lie or respectively may lie.

In some embodiments, it is provided that the transmitted electrical state data of the motor vehicles of the vehicle fleet are statistically evaluated, wherein the at least one reference value is determined and established on the basis of an evaluation result. This allows the at least one reference value to be determined and established particularly simply. In particular, value ranges for electrical quantities (e.g., current, voltage, operating point) can be efficiently determined and established through statistical methods on the basis of the detected electrical state data of the motor vehicles of the vehicle fleet. For example, starting from the transmitted state data, at least one distribution function can be determined. Starting from the at least one determined distribution function, the at least one reference value, in particular in the form of a value range, can be determined and established. If a distribution of a current of a line branch considered by way of example corresponds, for example, to a normal distribution across the vehicle fleet, a reference value for this line branch can be determined and established with regard to the current, starting from an average value and a standard deviation of the normal distribution. Subsequently, it can be provided that it is checked during the comparison whether or not an electric current detected for this line branch (as part of the electrical state data) lies within a single (alternatively double or triple, etc.) standard deviation around the average value. If the current does not lie within a single standard deviation, an error is found for this line branch and corresponding information is provided as part of the electrical system state. On the other hand, if the current lies within the standard deviation around the average value of the distribution, proper function is found and corresponding information is provided in the context of the electrical system state. This procedure takes place in particular for each line branch individually. In particular, a current, a voltage, an operating point derived therefrom, or also an electrical resistance can be considered as electrical quantities. In addition to a normal distribution, other statistical distributions can also be used if they better describe a distribution of the electrical quantities. Furthermore, forming average values is also possible in order to determine the at least one reference value.

In some embodiments, it is provided that the determined electrical system state of the at least one motor vehicle is transmitted to the at least one motor vehicle and/or a manufacturer of the motor vehicle and/or a service provider. This allows (continuous) feedback to take place, so that, for example, a vehicle owner and/or the manufacturer and/or the service provider are informed about the electrical system state.

In some embodiments, it is provided that at least one maintenance recommendation is generated and provided depending on the determined electrical system state of the at least one motor vehicle. This takes place in particular by means of the central server. If a current or an operating point of a line branch of the electrical system lies, for example, outside of a value range specified via the at least one reference value for this line branch, a maintenance recommendation can be generated and provided in a targeted manner for the associated line branch of the electrical system and/or for components supplied through the line branch. The maintenance message can be saved to be called up, for example, in a database. In a subsequent maintenance of the associated motor vehicle, the maintenance message can be called up from the database and the line branch or respectively the associated components can be checked in a targeted manner. A targeted maintenance recommendation can reduce effort and costs. Overall, the motor vehicle can be kept in better condition, in particular predictively.

In some embodiments, it is provided that the generated and provided maintenance recommendation is transmitted to the at least one motor vehicle and/or a service provider. The at least one maintenance recommendation is transmitted, for example, to the respective motor vehicle and displayed there as a message on a display apparatus (e.g., “Have line branch X checked” or if there is only one component on a line branch: “Have engine-independent air heating system checked”).

In some embodiments, it is provided that additionally detected component state data of at least one component, supplied by the power distribution unit, of the at least one motor vehicle are transmitted to the central server, wherein the transmitted component state data are taken into account when determining and establishing the at least one reference value and/or during the comparison. The component state data are detected and transmitted to the central server in each case by the at least one component itself. The component state data comprise in particular a current, a voltage, an output, and/or an operating point of the respective component. In the central server, it can be checked during the comparison, for example, whether a sum of the currents or of the outputs that are detected by individual components supplied through a line branch matches with a current or respectively an output detected by the power distribution unit. If the electrical quantities do not match, this can indicate an error. In the provided electrical system state, such an error is then taken into account or noted.

In some embodiments, it is provided that aging effects are taken into account when determining and establishing the at least one reference value and/or during the comparison. Aging effects comprise here in particular an increase in an electrical resistance of elements of a component with increasing age. Such an increase is caused by material aging of the elements and leads to an elevation of the electric current. Since such a behavior occurs regularly, this is taken into account during the comparison, for example in that an age of the component(s) at a line branch is determined or estimated, for example, via a year of manufacture of the motor vehicle, and, for example, a value range for currents or operating points of the line branch with these component(s) is chosen or adapted depending on the year of manufacture. The adaptation can take place, for example, with the aid of known aging models.

It can also be provided that the at least one motor vehicle monitors aging effects itself, for example by checking on the vehicle side whether or not the detected state data are past an aging curve estimated for the respective electrical quantities. Starting from a check result, for example, a correspondingly worded error message can be transmitted along with the transmitted state data.

Further features for the design of the system, the motor vehicle and the central server are apparent from the following description of further embodiments.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

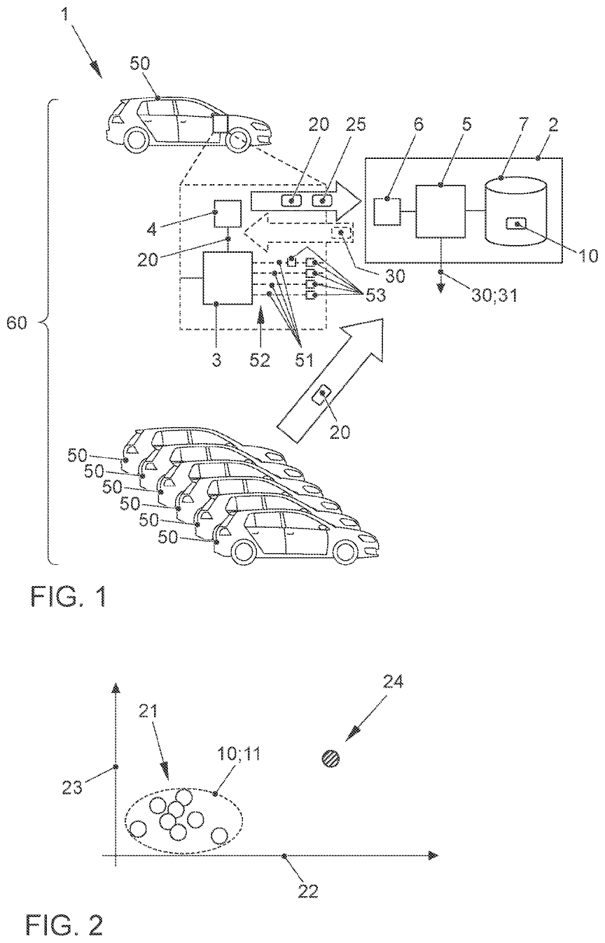

FIG. 1 shows a schematic representation of an embodiment of the system 1 for determining an electrical system state of at least one motor vehicle 50. The system 1 comprises motor vehicles 50 and a central server 2.

Each motor vehicle 50 comprises a power distribution unit 3 and a communications interface 4. The power distribution unit 3, which can also be described as a PDU or an ePDU, connects an electrical energy source (not shown) of the motor vehicle 50 to line branches 51 of an electrical system 52 (shown only partially) of the motor vehicle 50. In particular, the power distribution unit 3 protects the line branches 51 with the aid of semiconductor fuses (not shown) and detects at least one electric current at each of the line branches 51 for this purpose. The detected currents are continuously compared in the power distribution unit 3 with a trip current. If the trip current is exceeded at a line branch 51, an electrical connection to this line branch 51 is disconnected.

The central server 2 comprises a computing apparatus 5, a communications interface 6, and a memory apparatus 7. The computing apparatus 5 can execute computing operations 5 in the memory apparatus 7 to execute the method.

The power distribution unit 3 of the motor vehicle 50 detects electrical state data 20 of the motor vehicle 50. The electrical state data 20 comprise a current detected current and a current detected voltage for each line branch 51.

The detected electrical state data 20 are transmitted to the central server 2 by means of the communications interface 4.

The central server 2 receives the transmitted electrical state data 20 via the communications interface 6. The transmitted electrical state data 20 are compared in the central server 2 with at least one reference value 10, wherein these are in particular reference values 10 for the currents and the voltages of the individual line branches 51. The comparison is performed by the computing apparatus 5 and takes place for each line branch 51 individually. In particular, it is checked whether the current detected currents and the current detected voltages of the individual line branches 51 lie within value ranges specified by means of the reference values 10.

Starting from a comparison result, the electrical system state 30 of the at least one motor vehicle 50 is determined and provided. In this case, the electrical system state 30 comprises in particular information for each line branch 51 regarding how a comparison with the at least one reference value 10 has turned out; in particular, the electrical system state 30 comprises information about whether or not a value range for a current and/or a voltage was exceeded. If a value range was exceeded, the information contains in particular an error message for the associated line branch 51, otherwise a positive feedback that the line branch 51 is error-free.

It can be provided that the at least one reference value 10 establishes at least one operating point, in particular a value range for operating points, for the line branches 51 of the electrical system 52 and/or of at least one component 53 on the line branch 51 of the electrical system 52 of the motor vehicle 50. During the comparison, operating points calculated from the current and the voltage are then compared with the reference values 10, in particular with the value ranges.

In one embodiment, it is provided that the at least one reference value 20 is determined and established taking into account transmitted electrical state data 20 from motor vehicles 50 of a vehicle fleet 60.

FIG. 2 shows a schematic representation to illustrate an embodiment of determining and establishing the at least one reference value 10. In the lower left region, operating points 21 of the same line branch of electrical systems of motor vehicles of a vehicle fleet (cf. FIG. 1) are plotted. In this case, a voltage is shown on an x-axis 22 and a current is shown on a y-axis 23. The operating points 21 of the motor vehicles of the vehicle fleet all lie near each other. Starting from the operating points 21, detected or respectively calculated for the line branch being considered, of the vehicle fleet, a value range 11 is established in which the operating points 21 of the line branch being considered are in the normal case, meaning without an error being present. This value range is established as reference values 10. In this example, the reference values 10 form a two-dimensional set that has a shape similar to an ellipse.

In particular, it can be provided that the transmitted electrical state data (in the example shown in FIG. 2, the operating points 21) of the motor vehicles of the vehicle fleet are statistically evaluated, wherein the at least one reference value 10 is determined and established on the basis of (meaning starting from) an evaluation result. In the example shown in FIG. 2, for example, a two-dimensional normal distribution can be adapted (fitted) to the operating points 21 in the lower left region, for example via a regression method. The normal distribution that has been adapted in this way is subsequently used as value range 11 for the at least one reference value 10, wherein the dotted line indicates, for example, a single standard deviation around a midpoint of the normal distribution.

In the upper right region, FIG. 2 shows a current operating point 24 detected or respectively calculated at the considered line branch by a power distribution unit. As can be clearly seen, this is far away from the other operating points 21 and thus outside of the single standard deviation of the normal distribution, or respectively outside of the value range 11 or respectively the at least one reference value 10. During the comparison, this deviation is established. An electrical system state provided starting from a comparison result then comprises an error message for the associated line branch, for example that the detected or respectively calculated operating point 23 is not normal or is faulty.

It can be provided that the determined electrical system state 30 of the at least one motor vehicle 50 is transmitted to the at least one motor vehicle 50 and/or a manufacturer of the motor vehicle 50 and/or a service provider (FIG. 1). This takes place, for example, via the communications interfaces 4, 6.

It can be provided that at least one maintenance recommendation 31 is generated and provided depending on the determined electrical system state 30 of the at least one motor vehicle 50. The at least one maintenance recommendation 31 comprises at least one indicator or information about the corresponding line branch 51 being faulty.

In some embodiments, it can be provided that the generated and provided maintenance recommendation 31 is transmitted to the at least one motor vehicle 50 and/or a service provider.

It can furthermore be provided that additionally detected component state data 25 of at least one component 53, supplied by the power distribution unit 3, of the at least one motor vehicle 50 is transmitted to the central server 2, wherein the transmitted component state data 25 are taken into account when determining and establishing the at least one reference value 10 and/or during the comparison. The component state data 25 can be queried, for example, via a CAN bus connection on the individual components 53 and transmitted to the central server 2.

Furthermore, it can be provided that aging effects are taken into account when determining and establishing the at least one reference value 10 and/or during the comparison. A normal aging behavior of components 53 of a line branch 51 can be taken into account, for example, by establishing or adapting the at least one reference value 10. The method is then performed with the adapted reference value 10.

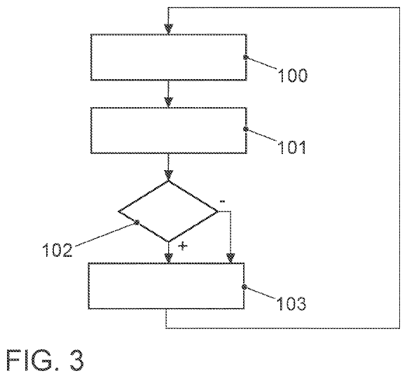

FIG. 3 shows a schematic process diagram of an embodiment of the method for determining an electrical system state of at least one motor vehicle.

In a measure 100, electrical state data of individual line branches of an electrical system of the at least one motor vehicle are detected on the vehicle side by means of a power distribution unit. The electrical state data comprise in particular a current current and a current voltage at the individual line branches. An operating point, for example, can be calculated from this and also transmitted. Furthermore, a line resistance can also be detected and transmitted.

In a measure 101, the detected electrical state data are transmitted to a central server by means of a communications interface.

In a measure 102, the transmitted electrical state data are compared on the server side with at least one reference value. This takes place in particular for each line branch of the electrical system individually or respectively separately. The at least one reference value indicates in particular a value range in which a current detected as state data and/or a voltage detected as state data and/or an operating point may lie or normally lie.

If the comparison results in all state data lying within the specified value ranges, in a measure 103 an electrical system state is determined and provided starting from the comparison result, and in particular transmitted to the at least one motor vehicle. The method is then repeated.

An example of the determined electrical system state for N line branches is:

| Line branch | Status |
|---|---|
| 1 | OK |
| 2 | OK |
| 3 | OK |
| . . . | OK |
| N | OK |

If the comparison in measure 102 results, however, in at least one quantity of the electrical state data not lying within the specified value ranges, this is noted accordingly in measure 103 in the provided electrical system state.

An example of the determined electrical system state for N line branches with one faulty line branch is:

| Line branch | Status |
|---|---|
| 1 | OK |
| 2 | Faulty |
| 3 | OK |
| . . . | OK |
| N | OK |

### LIST OF REFERENCE NUMERALS

1 System
2 Central server
3 Power distribution unit
4 Communications interface
5 Computing apparatus
6 Communications interface
7 Memory apparatus
10 Reference value
11 (Value) range
20 State data
21 Operating point
22 x-axis
23 y-axis
24 Current operating point
25 Component state data
30 Electrical system state
31 Maintenance recommendation
50 Motor vehicle
51 Line branch
52 Electrical system
53 Component
60 Vehicle fleet
100-103 Measures

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1. A method for determining an electrical system state of at least one motor vehicle, comprising:
detecting electrical state data of the at least one motor vehicle on the vehicle side using a power distribution unit in the at least one motor vehicle;
transmitting the detected electrical state data to a central server using a communications interface;
comparing the transmitted electrical state data on the server side with at least one reference value; and
determining and providing the electrical system state of the at least one motor vehicle on the basis of a comparison result.

2. The method of claim 1, wherein the at least one reference value establishes at least one operating point for at least one line branch of an electrical system and/or of at least one component of the at least one motor vehicle.

3. The method of claim 1, wherein the at least one reference value is determined and established taking into account transmitted electrical state data of motor vehicles of a vehicle fleet.

4. The method of claim 3, comprising statistically evaluating the transmitted electrical state data of the motor vehicles of the vehicle fleet evaluated, wherein the at least one reference value is determined and established on the basis of an evaluation result.

5. The method of claim 1, wherein the determined electrical system state of the at least one motor vehicle is transmitted to one or more of the at least one motor vehicle, a manufacturer of the motor vehicle, and a service provider.

6. The method of claim 1, comprising generating and providing at least one maintenance recommendation depending on the determined electrical system state of the at least one motor vehicle.

7. The method of claim 1, comprising transmitting additionally detected component state data of at least one component, supplied by the power distribution unit, of the at least one motor vehicle to the central server, wherein the transmitted component state data are taken into account when determining and establishing the at least one reference value and/or during the comparison.

8. A system for determining an electrical system state of at least one motor vehicle, comprising:
at least one motor vehicle with a power distribution unit and a communications interface; and
a central server,
wherein the power distribution unit is configured to detect electrical state data of the at least one motor vehicle and to transmit the detected electrical state data to the central server using the communications interface; and
wherein the central server is configured to compare the transmitted electrical state data with at least one reference value and, starting from a comparison result, to determine and provide the electrical system state of the at least one motor vehicle.

9. A motor vehicle for a system for determining an electrical system state of at least one motor vehicle, comprising a power distribution unit and a communications interface, wherein the power distribution unit is configured to detect electrical state data of the at least one motor vehicle and to transmit the detected electrical state data to the central server using the communications interface.

10. A central server for a system for determining an electrical system state of at least one motor vehicle, wherein the central server is configured to compare electrical state data transmitted by the at least one motor vehicle with at least one reference value and, starting from a comparison result, to determine and provide the electrical system state of the at least one motor vehicle.

11. The method of claim 2, wherein the at least one reference value is determined and established taking into account transmitted electrical state data of motor vehicles of a vehicle fleet.

12. The method of claim 11, comprising statistically evaluating the transmitted electrical state data of the motor vehicles of the vehicle fleet evaluated, wherein the at least one reference value is determined and established on the basis of an evaluation result.

13. The method of claim 2, wherein the determined electrical system state of the at least one motor vehicle is transmitted to one or more of the at least one motor vehicle, a manufacturer of the motor vehicle, and a service provider.

14. The method of claim 3, wherein the determined electrical system state of the at least one motor vehicle is transmitted to one or more of the at least one motor vehicle, a manufacturer of the motor vehicle, and a service provider.

15. The method of claim 4, wherein the determined electrical system state of the at least one motor vehicle is transmitted to one or more of the at least one motor vehicle, a manufacturer of the motor vehicle, and a service provider.

16. The method of claim 2, comprising generating and providing at least one maintenance recommendation depending on the determined electrical system state of the at least one motor vehicle.

17. The method of claim 3, comprising generating and providing at least one maintenance recommendation depending on the determined electrical system state of the at least one motor vehicle.

18. The method of claim 4, comprising generating and providing at least one maintenance recommendation depending on the determined electrical system state of the at least one motor vehicle.

19. The method of claim 5, comprising generating and providing at least one maintenance recommendation depending on the determined electrical system state of the at least one motor vehicle.

20. The method of claim 2, comprising transmitting additionally detected component state data of at least one component, supplied by the power distribution unit, of the at least one motor vehicle to the central server, wherein the transmitted component state data are taken into account when determining and establishing the at least one reference value and/or during the comparison.
